(19) United States
(12) Patent Application Publication
(10) Pub. No.: US 2007/0103075 A1
(43) Pub. Date: May 10, 2007

(54) Green sheet for black layers, plasma display panels using the green sheet and methods for fabricating the plasma display panels

(76) Inventors: Je Seok Kim, Anyang-si (KR); Dae Hyun Park, Yongin-si (KR); Byung Hwa Seo, Seoul (KR); Moon Bong Song, Seoul (KR); Byung Gil Ryu, Seoul (KR); Won Seok Jeon, Suwon-si (KR); Hong Cheol Lee, Masan-si (KR)

Correspondence Address: KED & ASSOCIATES, LLP, P.O. Box 221200, Chantilly, VA, 20153-1200, US

(21) Appl. No.: 11/593,634

(22) Filed: Nov. 7, 2006

(30) Foreign Application Priority Data
Nov. 29, 2005 (KR) 10-2005-0115148
Nov. 7, 2005 (KR) 10-2005-0106134
Jan. 5, 2006 (KR) 10-2006-0001437

(51) Int. Cl. H01J 17/49

(52) U.S. Cl. 313/582

(57) ABSTRACT

A plasma display panel with improved brightness and reduced discharge voltage is disclosed. The plasma display panel comprises an upper panel and a lower panel facing each other through barrier ribs wherein a first dielectric layer is formed on the upper panel and second dielectric layers containing a black pigment are formed by patterning on the first dielectric layer.

This application claims the benefit of Korean Patent Application No. 10-2005-0115148, filed on Nov. 29, 2005, No. 10-2005-0106134, filed on Nov. 7, 2005, No. 10-2006-0001437, filed on Jan. 5, 2006 which is hereby incorporated by reference as if fully set forth herein.

### BACKGROUND OF THE INVENTION

1. Field of the Invention

The present invention relates to plasma display panels, and more particularly, to the formation of black dielectric layers and black top layers to improve the brightness and reduce the discharge voltage of plasma display panels.

2. Discussion of the Related Art

Plasma display panels comprise an upper panel, a lower panel, and barrier ribs formed between the upper and lower panels to define discharge cells. A major discharge gas, such as neon, helium or a mixed gas thereof, and an inert gas containing a small amount of xenon (Xe) are filled within the discharge cells. When a high-frequency voltage is applied to produce a discharge in the discharge cells, vacuum ultraviolet rays are generated from the inert gas to cause phosphors present between the barrier ribs to emit light, and as a result, images are created. Such plasma display panels have attracted more and more attention as next-generation display devices due to their small thickness and light weight.

FIG. 1 is a perspective view schematically showing the structure of a plasma display panel. As shown in FIG. 1, the plasma display panel comprises an upper panel 100 and a lower panel 110 joined in parallel to and at a certain distance apart from the upper panel. The upper panel 100 includes an upper glass plate 101 as a display plane on which images are displayed and a plurality of sustain electrode pairs, each of which consists of a scan electrode 102 and a sustain electrode 103, arranged on the upper glass plate 101. The lower panel 110 includes a lower glass plate 111 and a plurality of address electrodes 113 arranged on the lower glass plate 111 so as to cross the plurality of sustain electrode pairs.

Stripe type (or well type, etc.) barrier ribs 112 for forming a plurality of discharge spaces, i.e. discharge cells, are arranged parallel to each other on the lower panel 110. A plurality of address electrodes 113, which act to perform an address discharge, are disposed in parallel with respect to the barrier ribs to generate vacuum ultraviolet rays. Red (R), green (G) and blue (B) phosphors 114 are applied to upper sides of the lower panel 110 to emit visible rays upon address discharge, and as a result, images are displayed. A lower dielectric layer 115 is formed between the address electrodes 113 and the phosphors 114 to protect the address electrodes 113.

An upper dielectric layer 104 is formed on the sustain electrode pairs 103, and a protective layer 105 is formed on the upper dielectric layer 104. The upper dielectric layer 104, which is included in the upper panel 100, is worn out due to the bombardment of positive (+) ions upon discharge of the plasma display panel. At this time, short circuiting of the electrodes may be caused by metal elements, such as sodium (Na). Thus, a magnesium oxide (MgO) thin film as the protective layer 105 is formed by coating to protect the upper dielectric layer 104. Magnesium oxide sufficiently withstands the bombardment of positive (+) ions and has a high secondary electron emission coefficient, thus achieving a low firing voltage.

However, the protective layer of the conventional plasma display panel has the following problems.

The barrier ribs of the plasma display panel are generally composed of a white material. The white material for the barrier ribs and the lower dielectric layer advantageously improve the brightness of the plasma display panel, but cause poor contrast of the plasma display panel.

Black layers are also formed on the barrier ribs to improve the contrast of the plasma display panel. An increase in the area of the black layers results in an increase in the contrast of the plasma display panel, but causes poor brightness of the plasma display panel.

Although the formation of black dielectric layers on the upper panel is also considered to improve the contrast of the plasma display panel, it may result in a decrease in the brightness of the plasma display panel.

### SUMMARY OF THE INVENTION

Accordingly, the present invention is directed to a green sheet for black layers, plasma display panels using the green sheet and methods for fabricating the plasma display panels that substantially obviate one or more problems due to limitations and disadvantages of the related art.

An object of the present invention is to provide a plasma display panel comprising an upper panel and black dielectric layers having differential step heights formed on the upper panel to improve the contrast and reduce the discharge voltage of the plasma display panel.

Another object of the present invention is to provide a plasma display panel comprising barrier ribs and black top layers formed on the barrier ribs to improve the contrast and brightness of the plasma display panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises an upper panel and a lower panel facing each other through barrier ribs wherein a first dielectric layer is formed on the upper panel and second dielectric layers containing a black pigment are formed by patterning on the first dielectric layer.

In another aspect of the present invention, there is provided a plasma display panel comprising an upper panel and a lower panel facing each other through barrier ribs wherein a first dielectric layer is formed on the upper panel, alkali-developable second dielectric layers are formed by patterning on the first dielectric layer, and third dielectric layers containing a black pigment are formed on the respective second dielectric layers.

In another aspect of the present invention, there is provided a plasma display panel comprising an upper panel and a lower panel joined to the upper panel through barrier ribs wherein black layers are formed on the respective barrier ribs and have a thickness of 0.1 to 5 micrometers.

In another aspect of the present invention, there is provided a method for fabricating a plasma display panel, the method comprising sequentially forming a material for barrier ribs and a material for black layers on a substrate, forming a photoresist pattern corresponding to a pattern of barrier ribs on the material for black layers, and etching the material for barrier ribs and the material for black layers using the photoresist pattern as a mask.

In another aspect of the present invention, there is provided a method for fabricating a plasma display panel, the method comprising forming a material for barrier ribs on a substrate, forming black layers having a pattern corresponding to a pattern of barrier ribs on the material for barrier ribs, and etching the material for barrier ribs using the pattern of the black layers as a mask.

In another aspect of the present invention, there is provided a green sheet for black layers comprising a photosensitive black paste sheet whose adhesiveness is maintained when not exposed to light and that is cured when exposed to light so as to lose its adhesiveness, and protective films formed on upper and lower surfaces of the photosensitive black paste sheet.

In yet another aspect of the present invention, there is provided a method for fabricating a plasma display panel, the method comprising preparing a photosensitive black paste sheet whose adhesiveness is varied in response to light exposure, selectively exposing the photosensitive black paste sheet to light such that the photosensitive black paste sheet has a pattern corresponding to a pattern of barrier ribs, and pressing the exposed black paste sheet on barrier ribs to transfer the unexposed portions of the black paste sheet to the barrier ribs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a general plasma display panel;

FIG. 2 is a cross-sectional view of an upper panel of a plasma display panel according to a first embodiment of the present invention;

FIGS. 3A to 3C are views illustrating a method for fabricating the plasma display panel according to the first embodiment of the present invention;

FIG. 4 is a view of a plasma display panel according to a second embodiment of the present invention;

FIG. 5 is a view of a plasma display panel according to a third embodiment of the present invention;

FIGS. 6A to 6D are views illustrating one method for fabricating the plasma display panel according to the third embodiment of the present invention;

FIGS. 7A to 7E are views illustrating another method for fabricating the plasma display panel according to the third embodiment of the present invention;

FIGS. 8A to 8C are views illustrating another method for fabricating the plasma display panel according to the third embodiment of the present invention;

FIG. 9 is a view of a green sheet for black layers according to an embodiment of the present invention; and

FIGS. 10A to 10D are views illustrating a procedure for forming black top layers of a plasma display panel using the green sheet for black layers shown in FIG. 9.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

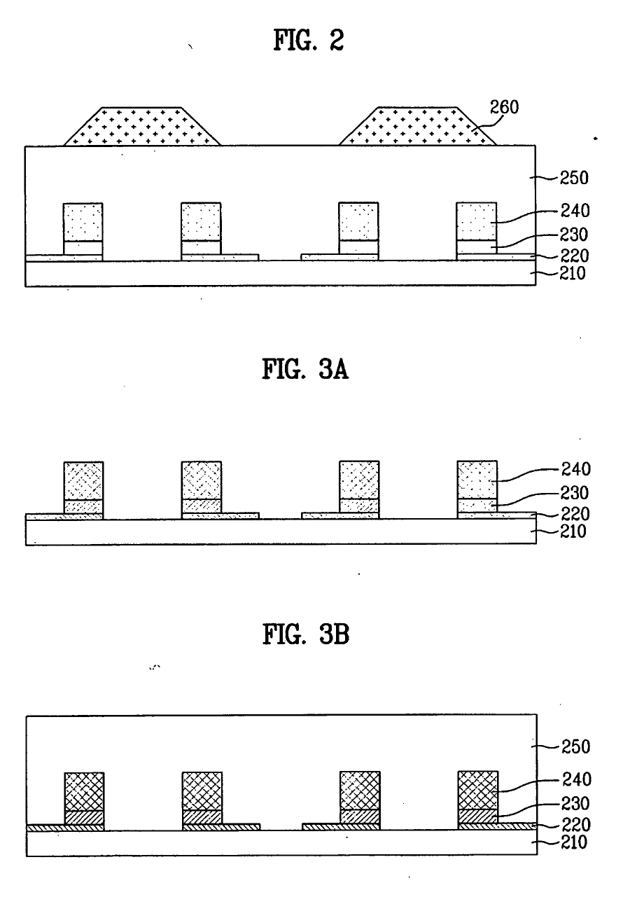

FIG. 2 is a cross-sectional view of an upper panel of a plasma display panel according to a first embodiment of the present invention. An explanation of the plasma display panel according to the first embodiment of the present invention will be provided below with reference to FIG. 2.

In the first embodiment, black matrix layers 230 are formed to prevent a deterioration in the contrast of the plasma display panel, which may be caused due to the presence of white barrier ribs formed on a lower panel. The black matrix layers 230 may be directly formed on the white barrier ribs. Alternatively, the black matrix layers 230 may be formed on respective transparent electrodes 220 of the upper panel, as shown in FIG. 2. Dielectric layers 260 (hereinafter, referred to as ‘second dielectric layers’) containing a black pigment are formed on an upper dielectric layer 250 (hereinafter, referred to as a ‘first dielectric layer’). Since the second dielectric layers 260 are formed on regions of the planar first dielectric layer 250, there is no need to form the black matrix layers 230 over large areas on sustain electrodes and an upper substrate. In addition, effects arising from the formation of the dielectric layers having differential step heights can be attained, thus enhancing the efficiency and brightness of the plasma display panel. The second dielectric layers 260 are disposed in regions between respective discharge cells to prevent a deterioration in the contrast of the plasma display panel, which may be caused due to the presence of white barrier ribs formed on a lower panel. In addition, the black matrix layers 230 formed on regions of the respective transparent electrodes 220 can prevent a deterioration in contrast, which may occur due to the reflection of external light incident on bus electrodes 240 formed on the black matrix layers 230.

When the sum of the height of the first dielectric layer 250 and that of each of the second dielectric layers 260 is 38 micrometers, the second dielectric layers 260 preferably have a height of 1 to 30 micrometers. The second dielectric layers 260 preferably have differential step heights, as shown in FIG. 2. The second dielectric layers 260 may be formed by applying a black dielectric paste over the entire surface of the first dielectric layer 250, followed by photolithography. The black dielectric paste used herein comprises a photosensitive organic material, a black pigment and a dielectric powder. Specifically, the second dielectric layers 260 are formed by the following procedure. First, the black dielectric paste containing the photosensitive organic material is formed over the entire surface of the first dielectric layer 250. Then, a photoresist (PR) is applied over the entire surface of the photosensitive organic material, followed by photolithography using a pattern mask to form the final second dielectric layers 260. At this time, the black dielectric paste may be prepared by milling a binder as a basic component constituting a matrix, a photopolymerizable monomer, a photopolymerization initiator, a dielectric powder and a black powder using a milling machine. Examples of the binder include acrylic, urethane and novolak resins. Examples of the photopolymerization initiator include benzophenone type initiators and triazine type initiators. Examples of the dielectric powder include PbO-based and non-PbO-based powders. Examples of the black powder include metal oxides capable of producing black, for example, Co₃O₄, chromium oxide, copper oxide and mixtures of two or more different oxides.

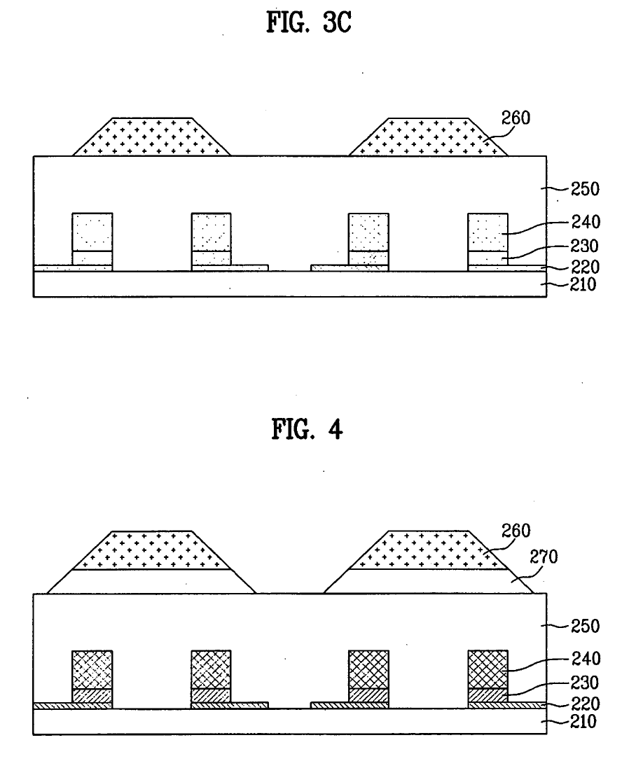

FIGS. 3A to 3C are views illustrating a method for fabricating the plasma display panel according to the first embodiment of the present invention. An explanation of the method for fabricating the plasma display panel according to the first embodiment of the present invention will be provided below with reference to FIGS. 3a to 3c.

Referring first to FIG. 3A, indium-tin-oxide (ITO) is applied to an upper glass plate 210 and patterned to form transparent electrodes 220. A black matrix is coated on top of the resulting structure and patterned to form black matrix layers 230 in regions where bus electrodes 240 are to be formed. The regions are upper edges of the transparent electrodes 220. Silver (Ag) is coated on top of the resulting structure and patterned to form the bus electrodes 240.

Then, as shown in FIG. 3B, a dielectric paste is coated on the resulting structure by screen printing, followed by drying/calcining to form a first dielectric layer 250. The first dielectric layer 250 may be formed by processes other than screen printing, e.g., by a table coating process using a table coater or a lamination process using a green sheet.

Then, as shown in FIG. 3C, a black dielectric paste is applied to the first dielectric layer 250. The black dielectric paste used herein comprises a photosensitive organic material, a black pigment and a dielectric powder. A photoresist (PR) is applied to the black dielectric paste and etched by photolithography using a pattern mask such that portions of the first dielectric layer 250 are etched to form second dielectric layers 260 having differential step heights.

An upper panel of a plasma display panel according to the first embodiment of the present invention is produced by the above procedure. The formation of the second dielectric layers 260 having differential step heights on the first dielectric layer 250 avoids the need to form black matrix layers between the respective transparent electrodes 220, which are regions between cells. In addition, since the dielectric layers have differential step heights, the discharge voltage of the plasma display panel can be reduced and the efficiency and brightness of the plasma display panel can be increased.

FIG. 4 is a view of a plasma display panel according to a second embodiment of the present invention. An explanation of the plasma display panel according to the second embodiment of the present invention will be provided below with reference to FIG. 4.

In the second embodiment, alkali-developable dielectric layers 270 are formed between respective second dielectric layers 260 and a first dielectric layer 250. The use of the alkali-developable dielectric layers 270, which are formed between the respective second dielectric layers 260 and the first dielectric layer 250, enables the second dielectric layers 260 to have differential step heights. That is, the step height between the second dielectric layers 260 and the first dielectric layer 250 can be easily controlled by varying the height of the alkali-developable dielectric layers 270. The height of the alkali-developable dielectric layers 270 may be varied depending on that of the second dielectric layers 260. Further, since the alkali-developable dielectric layers 270 are simultaneously developed upon development of the second dielectric layers 260, the height of the second dielectric layers 260 can be easily controlled by varying the development time.

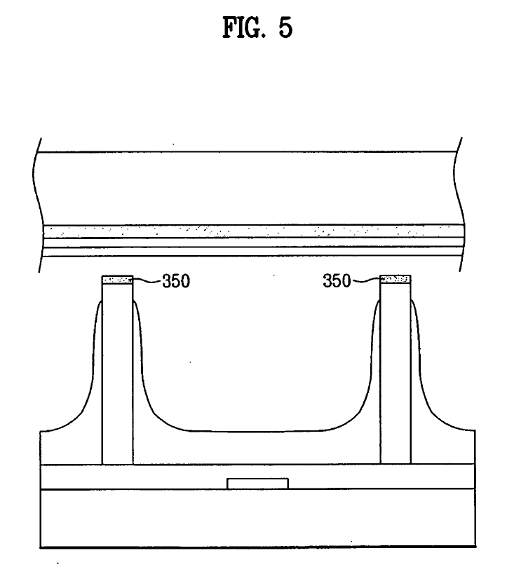

FIG. 5 is a view of a plasma display panel according to a third embodiment of the present invention. An explanation of the plasma display panel according to the third embodiment of the present invention will be provided below with reference to FIG. 5.

A conventional three-electrode surface-discharge plasma display panel comprises an upper panel, a lower panel arranged parallel to the upper panel, and barrier ribs having a height of about 150 micrometers formed between the upper and lower panels to define respective discharge cells. The barrier ribs are formed of a white dielectric having a high reflectivity to prevent a deterioration in the brightness of the plasma display panel, which is caused by a loss in visible rays emitted from phosphors. The white barrier ribs serve to increase the brightness of the plasma display panel, but result in poor bright room contrast of the plasma display panel. Thus, various methods have been proposed to improve the bright room contrast of plasma display panels. In this embodiment, black layers 350 are formed on respective barrier ribs to improve the bright room contrast of the plasma display panel. The black layers 350 preferably have a thickness of 0.1 to 5 micrometers. As apparent from the following test examples, when the thickness of the black layers 350 was maintained constant (5 μm or less), there was very little decrease in brightness and brightness efficiency due to the presence of the black ribs, and at the same time, an improvement in bright room contrast due to the presence of the black ribs could be maintained.

From the data shown in Table 1, it could be confirmed that black layers having a thickness of about 2.0 micrometers were formed on barrier ribs. Table 1 shows the measurement results for the brightness, brightness efficiency and bright room contrast of a 7.5″ display panel (Example 1) having a barrier rib structure in which black layers having a thickness of 2 μm were laminated on respective white ribs. For the comparison with the results of Example 1, Table 1 shows the measurement results of a 7.5″ plasma display panel (Reference Example 1) having a structure in which no black layer was formed on barrier ribs and those of a 7.5″ plasma display panel (Comparative Example 1) having a structure in which black layers having a thickness of about 15 μm were formed on respective barrier ribs. A photosensitive green sheet was used to form the black layers of the panel of Example 1, as described in the procedure that follows, and screen printing was employed to form the black layers of the panel of Comparative Example 1.

TABLE 1

| Example | Presence of | Thickness of | | Brightness | Reflectivity | Bright room |
|---|---|---|---|---|---|---|
| No. | black layers | black layers | Brightness | efficiency | of panel | contrast |
| Reference | No | — | 177 | 1.42 | 29.88 | — |
| Example 1 | | | | | | |
| Example 1 | Yes | 2 μm | <−1% | Comparable | −10% | +7% |
| Comparative | Yes | 15 μm | >−15% | −8% | −10% | +7% |
| Example 1 | | | | | | |

As can be seen from the results of Table 1, the brightness and brightness efficiency of the plasma display panel of Example 1 were comparable to those of the plasma display panel of Reference Example 1 comprising no black layer. In addition, the bright room contrast of the plasma display panel of Example 1 was improved by about 7% when compared to that of the plasma display panel of Reference Example 1. The plasma display panel of Comparative Example 1 comprising black layers showed improved bright room contrast, as the plasma display panel of Example 1, but showed considerably deteriorated brightness and brightness efficiency, unlike the plasma display panel of Example 1. That is, the relationships among the thickness of black layers and brightness efficiency and bright room contrast of plasma display panels will be explained below. The following explanations are provided only to assist in a further understanding of effects peculiar to the present invention, but the present invention is not to be construed as being limited thereto.

Black layers absorb visible light emitted from phosphors present between respective discharge cells. The absorption of visible light causes decreases in the brightness and brightness efficiency of the discharge cells, leading to a decrease in the overall brightness (brightness efficiency) of a panel. This decreased brightness (brightness efficiency) due to the black layers will be dependent on the surface area of the black layers. The surface area of the black layers includes the area of upper surfaces of the black layers facing a front plate and the area of side surfaces of the black layers facing the discharge spaces. The area of the upper surfaces is proportional to the width of barrier ribs, and the area of the side surfaces is proportional to the thickness of the black layers. Generally, as the area of the black layers is decreased, visible light absorbed by the black layers decreases. Particularly, the side surfaces of the black layers adjacent to the phosphors present in the discharge spaces are directly exposed to visible light emitted from the discharge spaces. Accordingly, it is anticipated that the variation in the area of the side surfaces of the black layers will have a greater influence on the absorption of visible light than that in the area of the upper surfaces of the black layers. The reason why the plasma display panel of Example 1 showed slightly decreased brightness as compared to the plasma display panel of Comparative Example 1 is believed to be due to the fact that the black layers of the plasma display panel of Example 1 had a smaller thickness than those of the plasma display panel of Comparative Example 1.

On the other hand, the upper surfaces of the black layers of the plasma display panel of Example 1 had the same area as those of the conventional plasma display panels. Since the upper surfaces of the black layers of the plasma display panel of Example 1 face a front plate, they are mainly involved in the absorption of external visible light incident through the front plate. If the upper surfaces of the black layers of the plasma display panel of Example 1 are designed to have the same area as that of the conventional plasma display panels, the bright room contrast of the plasma display panel of Example 1 is not substantially decreased despite a decrease in the area of the side surfaces.

Hereinafter, preferred examples of a method for fabricating the plasma display panel according to the third embodiment of the present invention will be explained. Although these preferred examples are associated with the formation of barrier ribs on a lower plate, those skilled in the art will appreciate that various modifications and changes, for example, the formation of the barrier ribs on a front plate, may be made to the method within the scope of common techniques.

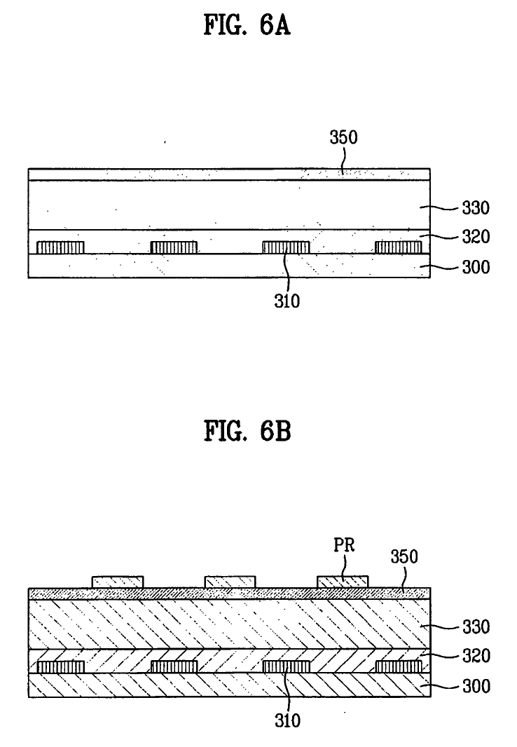

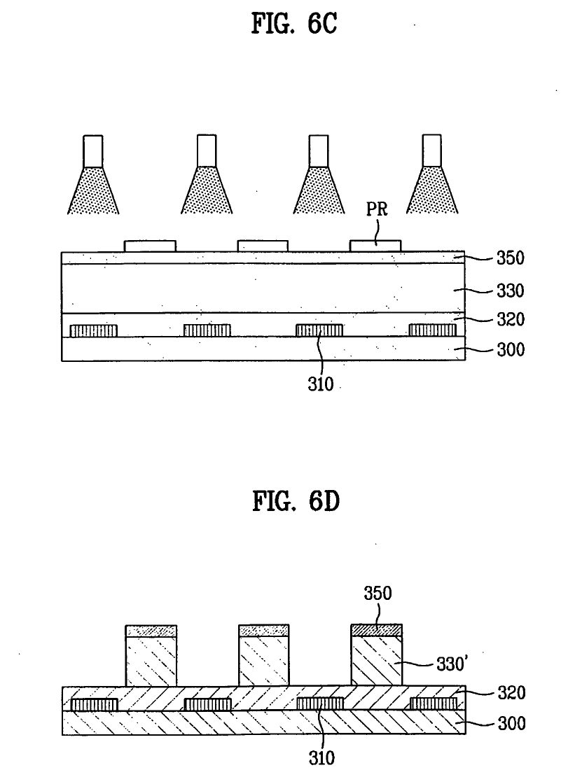

FIGS. 6A to 6D are views illustrating one method for fabricating the plasma display panel according to the third embodiment of the present invention. An explanation of the method for fabricating the plasma display panel according to the third embodiment of the present invention will be provided below with reference to FIGS. 6A to 6D.

First, a lower plate 300 of the plasma display panel is produced by sand blasting. Referring first to FIG. 6A, address electrodes 310 and a dielectric layer 320 are formed on the lower glass plate 300. Thereafter, a material for barrier ribs 330 and a material for black layers 350 are sequentially formed on the dielectric layer 320, followed by pre-baking. At this step, the material for barrier ribs 330 and the material for black layers 350 may be formed by a common process, such as spin coating and lamination of a green sheet. The barrier ribs 330 are formed from a composition comprising a glass powder, an organic binder and other additives. As the glass powder, a general silicate glass powder, e.g., SiO₂—ZnO—PbO—B₂O₃ glass powder, may be used. The black layers 350 may be formed from a composition comprising the materials for the formation of the white ribs and a small amount of an inorganic black pigment. The content of the inorganic solids in the composition is preferably 30% or less, based on the total solids content of the composition. The content of the inorganic solids constituting the black rib layers is preferably applied to the other methods of the present invention. The reason why the content of inorganic solids is maintained at a low level is to maintain the thickness of the black ribs after calcining at a level of 5 μm or less.

Subsequently, as shown in FIG. 6B, a photosensitive composition or a dry film resist (DFR) is applied to the material for black layers 350 to form a photosensitive layer. The photosensitive layer is exposed to light and developed to form a photoresist pattern (PR) covering regions where barrier ribs are to be formed. Referring to FIG. 6C, the photoresist pattern (PR) is used as an etching mask to sand-blast the barrier ribs and the black layers. The photoresist pattern (PR) is stripped to form a pattern having a laminate structure consisting of the barrier ribs 330 and the black layers 350 formed on the dielectric layer 320, followed by calcining to complete the formation of the final barrier ribs (FIG. 6D).

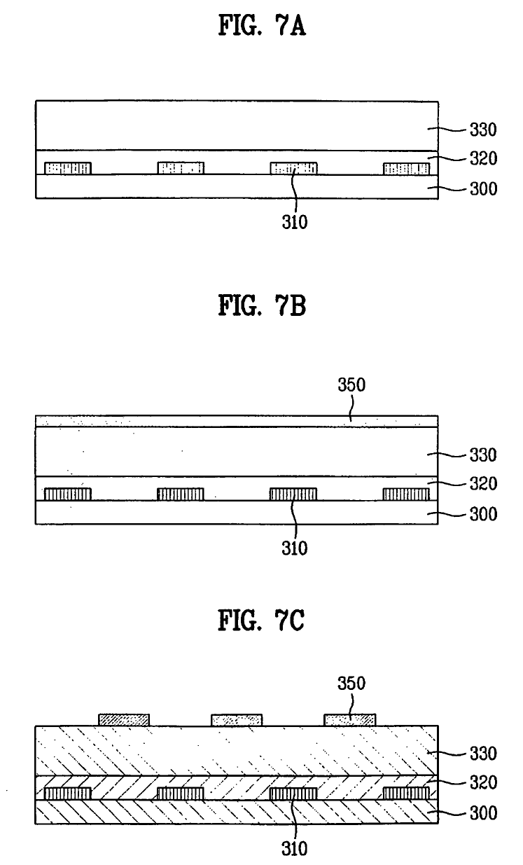

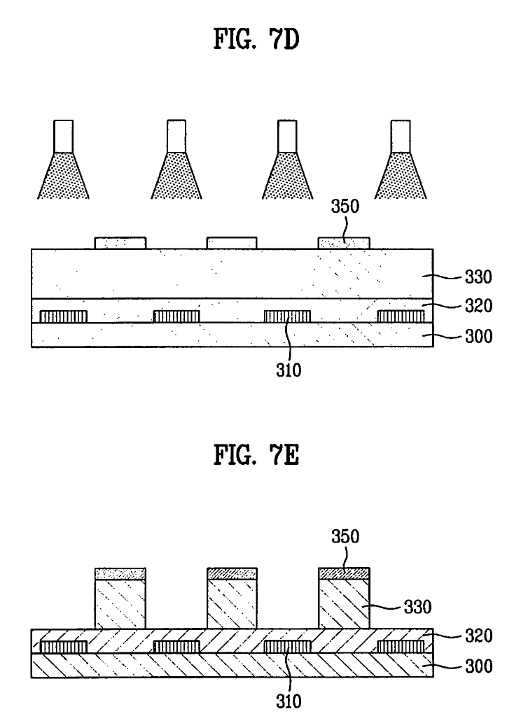

FIGS. 7A to 7E are views illustrating another method for fabricating the plasma display panel according to the third embodiment of the present invention. An explanation of the method for fabricating the plasma display panel according to the third embodiment of the present invention will be provided below with reference to FIGS. 7A to 7E.

First, as shown in FIG. 7A, address electrodes 310, a dielectric layer 320 and a material for barrier ribs 330 are sequentially formed on a lower glass plate 300, followed by pre-baking. This procedure may be carried out in the same manner as described in FIG. 6A. Next, as shown in FIG. 7B, a material for photosensitive black layers 350 is formed on the material for barrier ribs 330. The material for photosensitive black layers 350 is preferably a composition comprising a common material for black layers and a photosensitive material. The photosensitive material may be composed of a base polymer, a photopolymerizable monomer and a photopolymerization initiator.

The photopolymerization initiator refers to a compound that is activated by ultraviolet rays, and examples thereof include: substituted and unsubstituted polynuclear quinones, such as 9,10-anthraquinone, 1-chloroanthraquinone, 2-chloroanthraquinone, 2-ethylanthraquinone, and 2-methylanthraquinone; aromatic quinones, such as benzophenone, Michler's ketone, 4,4-bis(diethylamino)benzophenone, and 4-methoxy-4-bisdimethyl aminobenzophenone; benzoin ethers, such as methylbenzoin and ethylbenzoin; and 2,4,5-triarylimidazole dimer. These photopolymerization initiators may be used alone or in combination thereof.

The photopolymerizable monomer refers to a monomer that is crosslinked by exposure and whose stable phase can be maintained during development. The photopolymerizable monomer is alkylene or polyakylene glycol di(meth)acrylate that is commonly used for the production of a dry film photoresist (DFR). Examples of suitable alkylene and polyakylene glycol di(meth)acrylates include triethylene glycol di(meth)acrylate, tetraethylene glycol di(meth)acrylate, trimethyol propane tri(meth)acrylate, ethylene di(meth)acrylate, glycerol di(meth)acrylate, glycerol tri(meth)acrylate, and ethoxylated bisphenol A di(meth)acrylate. These photopolymerizable monomers may be used alone or in combination thereof.

Referring to FIG. 7B, the material for photosensitive black layers 350 may be formed by laminating a green sheet or spin coating. Next, as shown in FIG. 7C, the material for photosensitive black layers 350 is exposed to light and developed to form photosensitive black layers 350 having a predetermined pattern. The photosensitive black layers 350 act as etching masks for sand blasting in subsequent processing. The reason why photosensitive black layers 350 can be used as etching masks is that the photosensitive black layers are essentially composed of an organic material resistant to etching, such as sand blasting. As a result, the photosensitive black layers 350 remain after etching. This procedure is shown in FIGS. 7D and 7E. Referring to FIG. 7E, the barrier ribs 330 and the black layer 350 remaining after etching are calcined to complete the formation of the final barrier ribs 350 and black layer 350.

The barrier ribs and the black layers are simultaneously patterned in FIGS. 6A to 6D, while the black layers are first patterned and the barrier ribs are then patterned using the black layers as masks in FIGS. 7A to 7E. The barrier ribs and the black layers may also be formed by wet etching. There is no large difference between the present method and the previous method, except that the barrier ribs and the black layers are etched using a wet etching solution.

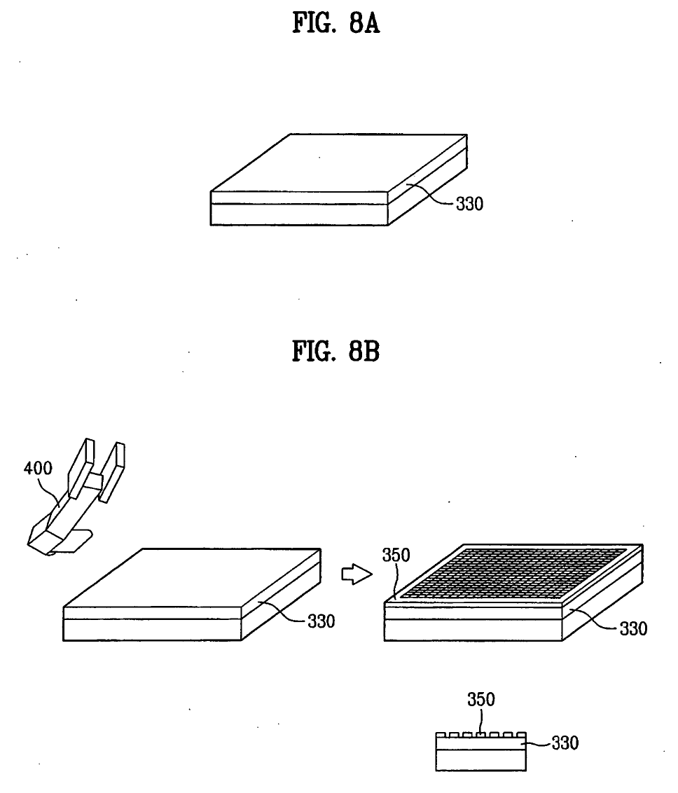

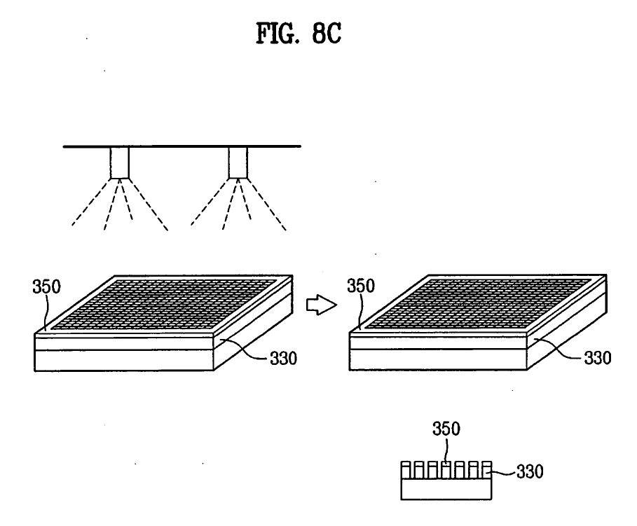

FIGS. 8A to 8C are views illustrating another method for fabricating the plasma display panel according to the third embodiment of the present invention. An explanation of the method for fabricating the plasma display panel according to the third embodiment of the present invention will be provided below with reference to FIGS. 8A to 8C.

First, as shown in FIG. 8A, electrodes (not shown), a dielectric layer (not shown) and a material for barrier ribs 330 are sequentially formed on a lower glass plate, followed by calcining. Then, as shown in FIG. 8B, a screen on which a pattern corresponding to a pattern of barrier ribs is formed, black layers 350, and a squeezer 400 are used to print black layers 350 on the barrier ribs 330. The cross-sectional shape of the black layers 350 formed on a substrate is shown at the bottom right of FIG. 8B. Subsequently, the printed pattern is dried and the underlying material for barrier ribs 330 is etched using the black layers 350 as etching masks to form a pattern of the barrier ribs 330. The pattern of the barrier ribs 330 is calcined to complete the formation of the final barrier ribs 330 and the final black layer 350 (FIG. 8C).

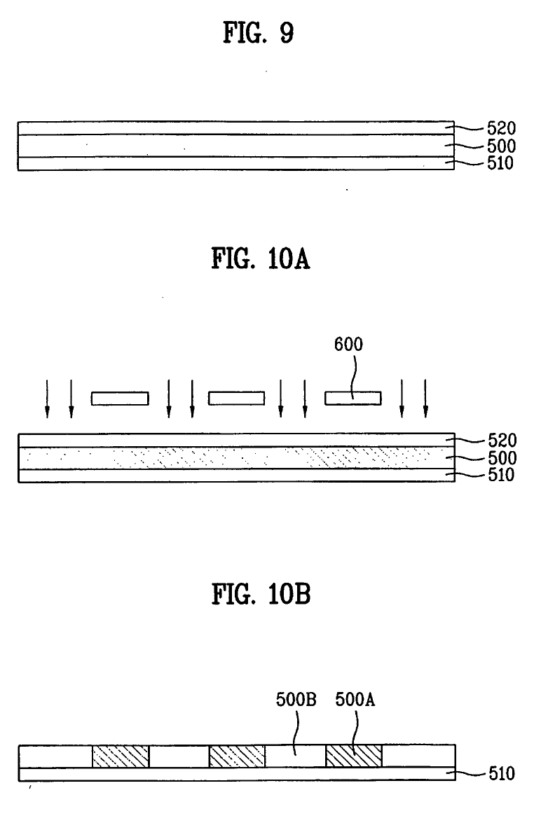

FIG. 9 is a view of a green sheet for black layers according to an embodiment of the present invention. An explanation of the green sheet for black layers according to the embodiment of the present invention will be provided below with reference to FIG. 9.

As shown in FIG. 9, the green sheet for black layers comprises a black paste sheet 500 that is sensitive to light exposure, and protective films 510 and 520 for protecting the upper and lower surfaces of the black paste sheet, respectively. Generally, green protective films for protecting a material layer are peeled to apply the material layer to a particular subject. The protective films and the material layer are collectively termed a ‘green sheet’, or the material layer only is also termed a ‘green sheet’. In this embodiment, the green sheet is considered to mean a device layer that is protected with protective films of a given color and is transferred to or laminated on a particular structure.

The black paste sheet 500 is a black material having light absorption characteristics (non-reflectivity of external light) that can be used to form black top layers or black matrix layers. The black paste sheet 500 is formed of a material whose adhesiveness is varied in response to irradiation with ultraviolet rays. The protective films 510 and 520 can be easily detached as required, and are attached with a certain adhesive force to the black paste sheet 500 to protect the sheet 500. Most importantly, the adhesiveness of the black paste sheet 500 must be varied in response to light exposure. To this end, a material that is sensitive to light exposure and has negative characteristics upon light exposure is used to prepare the black paste sheet 500. Exposed portions of a general material that is sensitive to light exposure and has negative characteristics upon light exposure are cured, while unexposed portions of the material are removed during development. In this embodiment, exposed portions in which the binding force of the sheet is strengthened are not used, and instead, unexposed portions in which a paste state is maintained are used. That is, the black paste sheet 500 is produced using an adhesive paste. When portions of the black paste sheet are exposed to light, strong binding occurs in the exposed portions, causing a loss in the softness and adhesiveness of the paste, while the unexposed portions still have inherent adhesiveness of the paste so that the unexposed portions can be laminated on barrier ribs.

The photosensitive material used to produce the black paste sheet 500 is a photosensitive polymeric material. The polymeric material is essentially composed of a polymeric compound and a photosensitizer. Since the photosensitive material has negative characteristics, the binding force of the polymeric compound must be enhanced upon photosensitization. In addition, the photosensitive material is thinly applied to barrier ribs to have a thickness sufficient to perform the functions as black layers while maximizing the reflection properties of the barrier ribs. Thus, it is preferred that the thickness of the black paste sheet be 30% or less of the actual thickness of barrier ribs. Since the brightness is increased with decreasing thickness of the applied photosensitive material, the photosensitive material can perform functions of black top layers to inhibit reflected light. The thickness of the photosensitive material is preferably as small as possible so long as the black paste sheet can be physically maintained.

To achieve desired reflectivity and color (i.e. black) and to attain changes in adhesiveness by light exposure, the black paste sheet 500 may be essentially composed of a photosensitive material, a black inorganic pigment, an organic binder (e.g., a glassy binder), and a solvent. Although the black paste sheet 500 is adhesive, the respective protective films 510 and 520 formed on the upper and lower surfaces of the black paste sheet 500 must be relatively easily detached. Accordingly, the protective films are preferably surface-coated so as to have a certain adhesive force without being affected by the adhesiveness of the black paste sheet 500. For photosensitization of the black paste sheet 500, the protective films 510 and 520 for protecting at least one surface of the black paste sheet 500 must be transparent to ultraviolet rays. There are commercially available protective film products whose surface is coated to be easily attached and detached and to have adhesiveness. Commercially available products having desired characteristics can be used as the protective films 510 and 520.

The green sheet for black layers may be used for the purpose of forming black layers on barrier ribs. Alternatively, the green sheet for black layers may be used to form black matrix layers. The green sheet for black layers may be utilized in various applications for the formation of black layers. The green sheet is transferred to or laminated on a particular structure to form black layers in a simple manner rather than application of a material for black layers to a structure and patterning of the applied material to form black layers. Even in the case where printing is not suitable for the formation of complicated structures having a limited thickness, such as black layers formed on barrier ribs, the green sheet for black layers can be easily used to form black layers having a small thickness. Particularly, the green sheet for black layers is highly applicable when the thickness of a layer to which the green sheet is applied is precisely maintained or when the application of patterning by etching is difficult and troublesome.

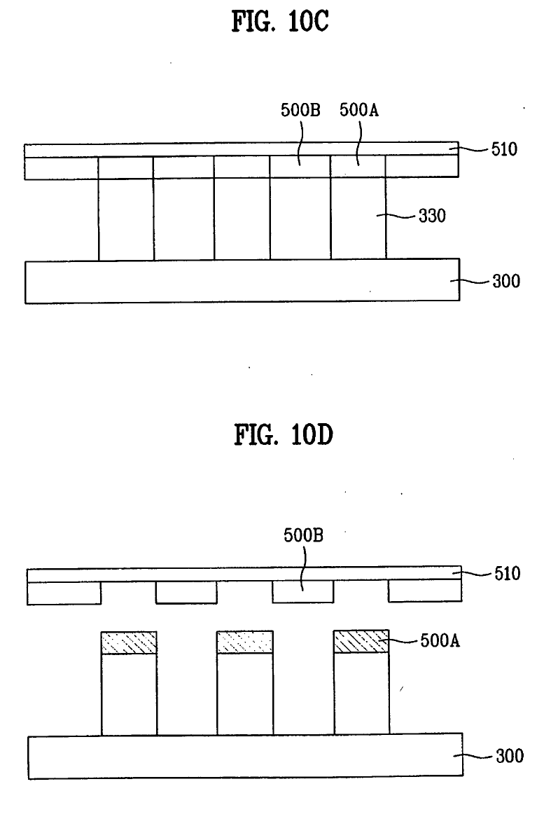

FIGS. 10A to 10D are views illustrating a procedure for forming black layers of a plasma display panel using the green sheet for black layers. An explanation of the procedure for forming black layers of a plasma display panel using the green sheet for black layers will be provided below with reference to FIGS. 10A to 10D.

As shown in the figures, after a photosensitive black paste sheet 500 is appropriately exposed to light to vary its adhesiveness, the varied adhesiveness is utilized to form black top layers. The black top layers are formed by the following procedure. First, as shown in FIG. 10A, a green sheet is prepared. The green sheet consists of a photosensitive black paste sheet 500 whose adhesiveness is varied in response to light exposure and protective films 510 and 520 for protecting the photosensitive black paste sheet 500. A photomask 600 is disposed over the black paste sheet, followed by irradiation with UV light. The photomask 600 is patterned to correspond to the position of barrier ribs to be formed and the width of the upper surfaces of the barrier ribs such that desired portions are not exposed. Since the black paste sheet 500 contains organic binders and a solvent, which serve to maintain the adhesiveness of the black paste sheet, its volume may be shrunk in subsequent drying and curing. Taking into consideration the volume shrinkage, a pattern of the photomask 600 is preferably formed in such a manner that portions having a larger area than the actual width of the upper surfaces of the barrier ribs are not exposed.

As shown in FIG. 10B, since strong binding of the polymeric material occurs in the exposed portions of the black paste sheet 500B by the light exposure, the adhesiveness of the black paste sheet 500B is lost in the exposed portions, which is then cured, and is maintained in the unexposed portions 500A. After completion of the exposure to vary the adhesiveness of the black paste sheet, the protective film 520 for protecting one surface of the black paste sheet 500 is removed to complete preparation for lamination.

Subsequently, as shown in FIG. 10C, a lower glass plate 300, on which barrier ribs 330 are formed by additional processing, is aligned to face to the black paste sheet 500, from which the protective film 520 is removed. The lower glass plate and the black paste sheet 500 are pressed to each other in such a manner that the unexposed portions 500A, in which the adhesiveness of the black paste sheet is maintained, are firmly attached to the barrier ribs 330. The lower glass plate 300 includes lower electrodes, a lower dielectric layer, and other elements, in addition to the barrier ribs 330. The barrier ribs 330 may be formed by the following procedures. A material for the barrier ribs is coated, deposited or laminated on the lower glass plate, etched, and patterned by sand blasting or polishing to form the barrier ribs 330. Alternatively, the barrier ribs 330 are formed by repeatedly pattering and printing a material for the barrier ribs on the lower glass plate. The barrier ribs 330 may be formed by various procedures. For example, the barrier ribs 330 may be formed by separately forming a structure of the barrier ribs 330 and adhering the structure to the lower glass plate 300.

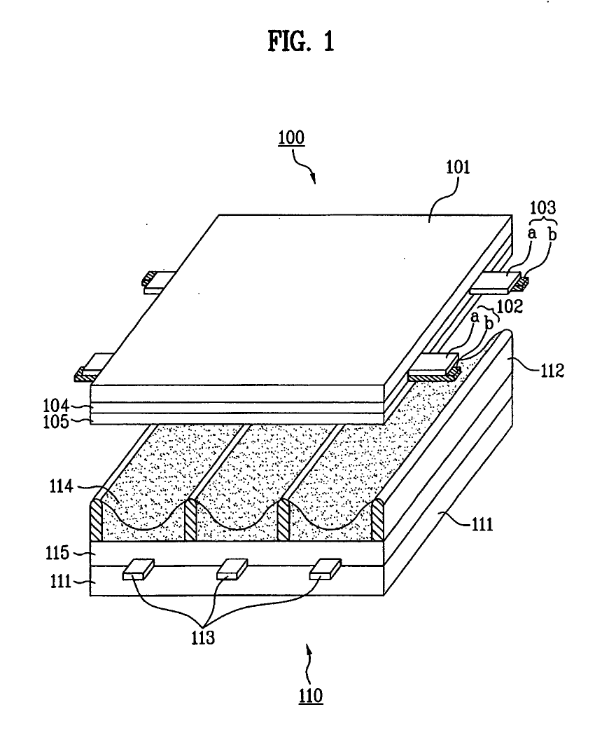

As shown in FIG. 1D, the black paste sheet 500 and the protective film 510, which functions to protect and fix one surface of the black paste sheet, are removed from the barrier ribs 330 to separate the exposed portions 500B of the black paste sheet 500 from the barrier ribs 330, leaving the unexposed portions 500A, in which the adhesiveness of the black paste sheet 500 is maintained, on the upper surfaces of the barrier ribs 330. The procedure shown in the figures is carried out by a transfer process wherein the unexposed portions 500A of the black paste sheet 500, from which the protective film 520 for protecting one surface of the black paste sheet 500 is removed, are aligned and pressed on the barrier ribs 330, and then the protective film 510 and the exposed portions 500B of the black paste sheet 500 are lifted off. Instead of the transfer process, the procedure may be carried out by a lamination process wherein pressing using rollers and removal are sequentially performed.

Although the procedures for forming black layers on barrier ribs of a plasma display panel have been disclosed in the foregoing embodiments, they can be employed for the purpose of forming black layers on barrier ribs of all kinds of display panels (including field emission display panels, OLED panels and LCD panels to which barrier ribs for defining and supporting cells can be applied) wherein the barrier ribs are arranged close to an upper plate so that the upper surfaces of the barrier ribs are visible from the outside of the upper plate.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising an upper panel and a lower panel facing each other through barrier ribs wherein a first dielectric layer is formed on the upper panel and second dielectric layers containing a black pigment are formed by patterning on the first dielectric layer.

2. The plasma display panel according to claim 1, wherein the second dielectric layers are patterned to have differential step heights.

3. The plasma display panel according to claim 1, wherein the second dielectric layers are patterned to be formed only in regions between respective discharge cells.

4. The plasma display panel according to claim 1, wherein the sum of the height of the first dielectric layer and that of each of the second dielectric layers is 38 micrometers, and the second dielectric layers have a height of 1 to 30 micrometers.

5. The plasma display panel according to claim 1, wherein the second dielectric layers are formed by applying a paste comprising a photosensitive organic material, a black pigment and a dielectric powder over the entire surface of the first dielectric layer, and patterning the paste by photolithography.

6. The plasma display panel according to claim 1, wherein the second dielectric layers are formed by milling a binder, a photopolymerizable monomer, a photopolymerization initiator, a dielectric powder and a black powder to prepare a paste, applying the paste over the entire surface of the first dielectric layer, and patterning the paste by photolithography.

7. The plasma display panel according to claim 6, wherein the black powder is selected from CO₃O₄, chromium oxide, copper oxide, and mixtures of two or more different oxides.

8. A plasma display panel comprising an upper panel and a lower panel facing each other through barrier ribs wherein a first dielectric layer is formed on the upper panel, alkali-developable second dielectric layers are formed by patterning on the first dielectric layer, and third dielectric layers containing a black pigment are formed on the respective second dielectric layers.

9. A plasma display panel comprising an upper panel and a lower panel joined to the upper panel through barrier ribs wherein black layers are formed on the respective barrier ribs and have a thickness of 0.1 to 5 micrometers.

10. The plasma display panel according to claim 9, wherein the barrier ribs and the black layers are formed by forming a material for the barrier ribs and a material for the black layers, and etching the materials using a photoresist pattern as a mask.

11. The plasma display panel according to claim 9, wherein the barrier ribs are formed by forming a material for the black layers by patterning on a material for the barrier ribs, and etching the material for the barrier ribs using the material for the black layers as a mask.

12. The plasma display panel according to claim 9, wherein the black layers are formed by forming a green sheet using a photosensitive black paste material, exposing and developing the green sheet, and transferring the developed green sheet to the barrier ribs.

13. A method for fabricating a plasma display panel, the method comprising sequentially forming a material for barrier ribs and a material for black layers on a substrate, forming a photoresist pattern corresponding to a pattern of barrier ribs on the material for black layers, and etching the material for barrier ribs and the material for black layers using the photoresist pattern as a mask.

14. The method according to claim 13, wherein the black layers have a thickness of 0.1 to 5 micrometers.

15. The method according to claim 13, wherein the content of inorganic solids in the material for black layers is 30% or less, based on the total solids content.

16. A method for fabricating a plasma display panel, the method comprising forming a material for barrier ribs on a substrate, forming black layers having a pattern corresponding to a pattern of barrier ribs on the material for barrier ribs, and etching the material for barrier ribs using the pattern of the black layers as a mask.

17. The method according to claim 16, wherein the black layers are formed using a material containing 30% or less of inorganic solids, based on the total solids content.

18. The method according to claim 16, wherein the black layers are formed by screen printing a material for the black layers patterned on the material for barrier ribs, followed by drying.

19. A green sheet for black layers comprising a photosensitive black paste sheet whose adhesiveness is maintained when not exposed to light and that is cured when exposed to light so as to lose its adhesiveness, and protective films formed on upper and lower surfaces of the photosensitive black paste sheet.

20. The green sheet according to claim 19, wherein the photosensitive black paste sheet is composed of a photosensitive material that is cured when exposed to light, a black inorganic pigment, and an organic binder.

21. The green sheet according to claim 19, wherein the protective films have surface characteristics to reduce the adhesiveness of the black paste sheet.

22. The green sheet according to claim 19, wherein at least one of the protective films is transparent to a light source for photosensitization.

23. A method for fabricating a plasma display panel, the method comprising preparing a photosensitive black paste sheet whose adhesiveness is varied in response to light exposure, selectively exposing the photosensitive black paste sheet to light such that the photosensitive black paste sheet has a pattern corresponding to a pattern of barrier ribs, and pressing the exposed black paste sheet on barrier ribs to transfer the unexposed portions of the black paste sheet to the barrier ribs.

24. The method according to claim 23, wherein the unexposed portions of the black paste sheet is transferred to the barrier ribs by aligning and pressing the unexposed portions of the black paste sheet on the barrier ribs, and removing the unexposed portions of the black paste sheet.

25. The method according to claim 24, wherein the pressing is performed by pressing a lower panel having the barrier ribs formed thereon and the black paste sheet using rollers.

26. The method according to claim 24, wherein the thickness of the black paste sheet is 30% or less of the thickness of the barrier ribs.
